(19) United States
(12) Patent Application Publication
(10) Pub. No.: US 2009/0160255 A1
(43) Pub. Date: Jun. 25, 2009

(54) UNINTERRUPTIBLE POWER SUPPLY

(76) Inventor: John K. Grady, Harvard, MA (US)

Correspondence Address: HOLLAND & BONZAGNI, P.C., 171 DWIGHT ROAD, SUITE 302, LONGMEADOW, MA, 01106-1700, US

(21) Appl. No.: 11/960,916

(22) Filed: Dec. 20, 2007

(51) Int. Cl. H02J 9/06

(52) U.S. Cl. 307/66

(57) ABSTRACT

An external uninterruptible power supply (“UPS”), and a related method, are presented in which a predetermined desired DC voltage potential is applied directly to the internal DC voltage power distribution bus in a computer. The UPS is configured to use an automotive battery to provide the predetermined desired DC voltage potential in the event of the loss of the AC voltage input signal. In a preferred embodiment, the UPS includes an inverterless AC-DC power supply, such as a bridge rectifier circuit, for supplying a predetermined desired direct current voltage potential at its output. That output potential in turn is carried by a suitably arranged cord or power cable connected to the internal direct current voltage distribution bus in the computer. The distribution bus may be connected to one or more points-of-load, also known as “point-of-power” voltage conversion modules, each of which provide a regulated voltage to power the various high density chip loads, components and circuitry in the computer. The input voltage to a point-of-load power chip can vary over a wide range allowing unregulated voltages ranging from 11 to 14 volts which may be used to supply the point-of-load power chips with no operating problems since the chips are inherently an on-card switching regulator operating at a high frequency.

### FIELD OF THE INVENTION

The present invention relates generally to uninterruptible power supplies and deals more particularly with an external uninterruptible power supply for use with a computer and more specifically with an uninterruptible power supply configured for direct connection to the internal DC voltage power distribution bus in the computer.

### BACKGROUND OF THE INVENTION

Uninterruptible power supplies, which are also known as “UPS” devices are used to maintain the operation of a desktop computer, point-of-sale computer terminal or other such device in the event of loss of the primary power source powering the computer. A schematic representation of an uninterruptible power supply, as used with a computer according to some embodiments of the prior art, is illustrated in FIG. 1. The uninterruptible power supply, generally designated by the reference numeral 10, has a male AC power plug 12 arranged for connection to a commercial alternating power source typically 115 volts, 60 hertz, and feeds the 115 volts through a switch transfer to a female AC power plug. The male AC power plug of the computer is connected to the female AC power plug to supply 115 volt, 60 hertz to an ATX type high frequency power supply in the computer. The ATX high frequency power supply converts the AC voltage into the DC voltages, typically +12, +5 and −12 direct current (DC) voltages that are in turn connected to the respective +12, +5 and −12 volt DC internal power distribution buses in the computer. In the event of the loss of the 115 AC voltage supply, the female AC power plug is connected to the output of a DC to AC voltage converter which converts a DC voltage supplied by a battery to a 115 volt, 60 hertz AC voltage to power the computer.

The uninterruptible power supplies such as described in connection with FIG. 1 have a number of drawbacks and shortcomings one of which is a relatively high power loss. The typical external UPS, such as described in FIG. 1, generates a 60 hertz alternating current voltage which is input to a high frequency power supply generally used in the computer. The 60 hertz AC voltage is produced in the UPS from a DC voltage battery using well known and understood DC-AC inverter circuit technology and topologies. The inverter circuits, also known as “high frequency power supplies”, typically have efficiencies ranging from 80 to 90 percent resulting in up to 20 percent of the battery capacity being wasted as heat during the conversion of the DC battery voltage to the 60 hertz AC voltage.

The DC voltage battery found in uninterruptible power supplies, such as shown in FIG. 1, have battery voltages ranging from 24 volts DC to 48 volts DC. Typically the battery is constructed of many low ampere-hour battery cells connected in series to provide the required magnitude DC voltage. The battery construction with so many battery cells sometimes leads to reliability problems. Battery cells within the series of battery cells tend to become mismatched during the cycling process over a period of time with one or more battery cells being over charged or under charged due to random slight differences in battery cell capacity (in ampere-hours) compared to the battery cell's neighbors and consequently subject to reverse voltages. A single defective cell can result in a reversed cell voltage, low voltage or no voltage, and the battery when in use will fail within minutes to deliver its rated capacity when it is most needed. This failure and operating characteristic is well known as demonstrated for example in nickel cadmium battery powered tools and existing uninterruptible power supplies.

Further, uninterruptible power supplies (like FIG. 1) typically lack the capacity to operate the computer for any appreciable time duration and tend to only support operation of the computer for a period of minutes to allow or orchestrate an orderly shutdown. Often, software is included with these uninterruptible power supplies to initiate an automatic shutdown of the computer to preserve data when a failure of the AC power source is detected. Such operation may not be desirable or wanted in some applications where it is necessary to maintain computer operation even during a failure of the AC power.

Further, the rated capacity of uninterruptible power supplies, such as illustrated in FIG. 1, may be misleading. It is usually specified in volt amperes or watts, both discharge rates, rather than watt hours which is the capacity and the value needed to support the computer operation for further use after the loss of the AC power. Also, the expected run time at full rating is generally not specified as the UPS generally will not meet the specification due to among other things the time dependent battery problems as generally discussed above. More elaborate and expensive UPS systems in the multi-kilowatt range size may use a “test run” to provide a projected run time based on the periodic discharge of the high voltage battery to evaluate its condition. The periodic discharging “test runs” further stress the high voltage battery “equality-of-charge” of the many battery cell arrangement. Periodic discharging results in shortening the battery life even if the battery is never used in an AC power failure situation. Accordingly a replacement of the battery is required at relatively frequent intervals. The cost per ampere-hour of the replacement battery, which is typically a “proprietary” battery, may be twice the cost per ampere-hour of a non-proprietary battery.

What is needed is an external, efficient uninterruptible power supply with sufficient capacity to power a computer for an extended period of time in the event of an AC power failure.

### SUMMARY OF THE INVENTION

In a broad aspect of the invention, an external uninterruptible power supply is presented in which a predetermined desired DC voltage potential is applied directly to the internal DC voltage power distribution bus in a computer. The uninterruptible power supply is configured to use an automotive battery to provide the predetermined desired DC voltage potential in the event of the loss of the AC voltage input signal.

### BRIEF DESCRIPTION OF THE DRAWINGS

FIG. 1 is a schematic representation of an uninterruptible power supply, as used with a computer, according to some embodiments of the prior art.

FIG. 2 shows a functional block diagram of an external uninterruptible power supply, according to some embodiments of the invention.

FIG. 3 is a flowchart showing the steps of the basic method, according to some embodiments of the present invention.

FIG. 4 shows a schematic functional block diagram of an external uninterruptible power supply, as it might be used with a computer, according to some embodiments of the present invention.

FIG. 5 is a functional block diagram of an example of a signal processor for carrying out the method of the invention.

FIG. 6 shows a schematic circuit representation of an external uninterruptible power supply, according to some embodiments of the present invention.

FIGS. 7a-7c show representative waveforms for the switching metal oxide semiconductor field effect transistors and power flow output in the AC-DC power supply in the external uninterruptible power supply, according to some embodiments of the present invention.

FIG. 8 shows a functional block diagram of an external uninterruptible power supply, according to some embodiments of the invention.

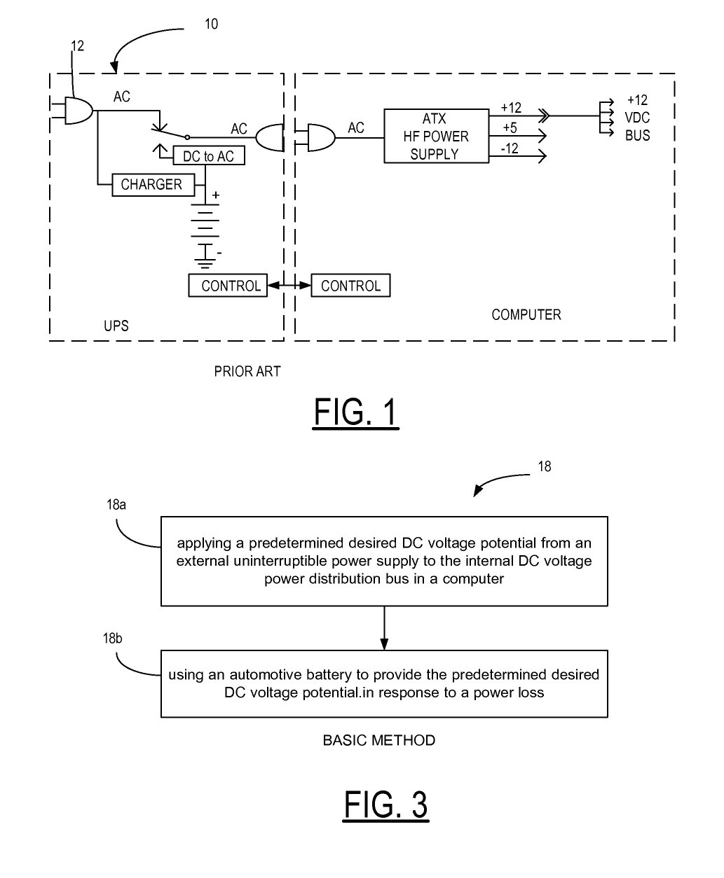

### DETAILED DESCRIPTION OF THE PREFERRED EMBODIMENTS

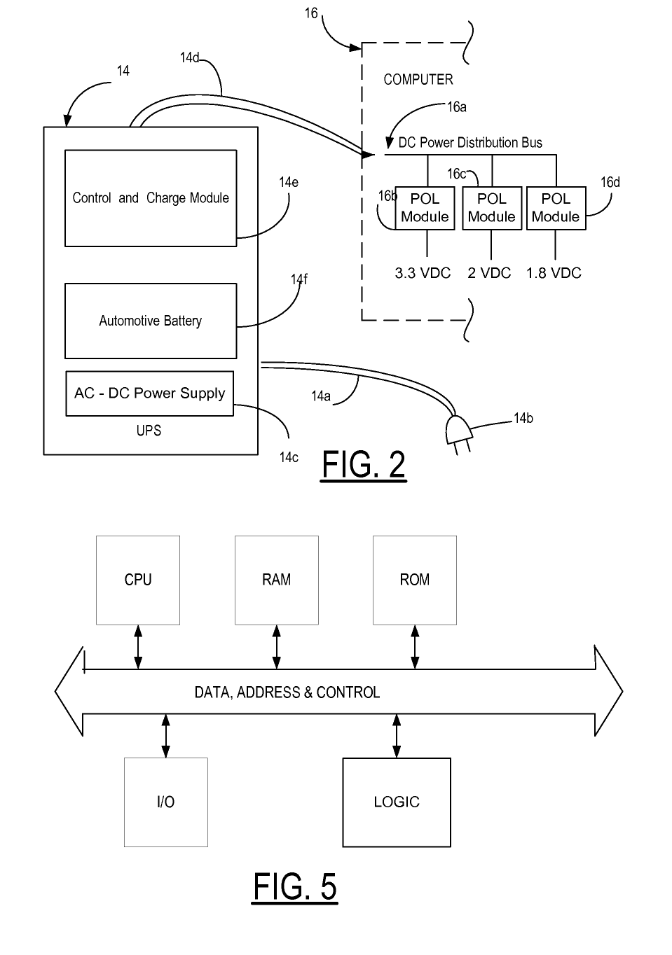

FIG. 2 is a functional block diagram of an external uninterruptible power supply (UPS), according to some embodiments of the invention. The UPS is generally designated 14 and shown for example as it might be connected to a computer, such as a desktop computer generally designated 16. The UPS 14 includes an AC cord 14a with a suitably configured AC plug 14b for connection to an alternating current voltage source, for example a 110 volt AC commercial voltage supply. The UPS includes an inverterless AC-DC power supply 14c, for example a suitably configured and arranged bridge rectifier circuit, for supplying a predetermined desired direct current voltage potential, for example +12 volts DC, at its output. This output in turn is carried by a suitably arranged cord or power cable 14d arranged for connection to the internal direct current voltage distribution bus 16a in the computer 16. The distribution bus 16a may be connected to one or more point-of-load, also known as “point-of-power” voltage conversion modules 16b, 16c, 16d. Each module provides a regulated voltage, for example, 3.3 VDC, 2.0 VDC, 1.8 VDC, to power the various high density chip loads, components and circuitry in the computer. The input voltage to a point-of-load power chip can vary over a wide range allowing unregulated voltages ranging from 11 to 14 volts to be used to supply the point-of-load power chips with no operating problems since the chips are inherently an on-card switching regulator operating at a very high frequency. Point of-load voltage conversion modules are known to those skilled in the art and the reader is referred to the literature in the art for further information.

The UPS 16 also includes a control and charge module 14e and an automotive battery 14f. The control and charge module is configured for detecting a loss of AC power and transferring the battery direct current output voltage to the UPS output which, in turn, is carried by the cable 14d to the internal direct current voltage distribution bus 16a in the computer 16 to power the computer during the loss of AC power event.

It should be noted that use of an unregulated voltage on the internal direct current voltage distribution bus, according to some embodiments of the invention, eliminates the use of the high frequency power supplies or inverters in the power distribution path between the battery and the computer internal direct current voltage distribution bus. They are not needed with the resultant improvement in efficiency and conservation of battery energy which leads to a longer operating time during an AC voltage power failure event. Typically there are two inverters in the power distribution path, one in the UPS to convert the battery DC voltage to a 60 hertz AC voltage and one in the computer, for example in the ATX form factor power chassis to convert the AC to the required DC voltages for distribution on the internal direct current voltage distribution bus. Each of the high frequency power supplies or inverters has an efficiency of about 80 percent and taken together sequentially, 0.80×0.80=0.64 so only about 65 percent of the original battery energy is used by the computer. In contrast, substantially 100 percent of the original battery energy is used by the computer, according to some embodiments of the present invention.

It should also be noted that in typical uninterruptible power supplies using the common inverter topology to provide 12 volts DC, at for example a 1000 watt rating, power semiconductor switching devices are required to switch approximately 100 amperes in the inverter. At such high currents the losses in the 1000 watt inverter are very high with about 90 watts for the switching transistors alone. Such high losses require aggressive fan cooling for heat transfer and dissipation which in turn added to the losses. Higher battery voltage designs in the 24 volt and 48 volt range were used to lower switching device losses and accordingly necessitated the use of non-standard or proprietary batteries which led to the reliability issues discussed herein above. Now according to some embodiments of the invention, the use of an automotive 12 volt battery and elimination of the use of inverters/converters, as discussed herein above, substantially overcomes the problem of high switching losses at low voltages and high current by eliminating the need for a large main switching power supply.

Further, by having only six battery cells in the 12 volt automotive battery rather than 24 battery cells in a 48 volt DC battery reduces the statistical chance of a cell mismatch. The battery cells in the 12 volt DC automotive battery are physically 4 times larger than the battery cells in the 48 volt DC battery and are more tolerant of slight imperfections than the battery cells in the 48 volt DC battery. Also, the automotive use of 12 volts DC has proven to be absolutely reliable without ongoing routine testing or evaluation and usable to start the automobile for at least four to five years.

It is further pointed out that according to some embodiments of the invention, a 40 percent to 45 percent improvement in efficiency may be obtained by eliminating the high frequency power supplies or inverters in the power path thus allowing for more available energy from the 12 volt DC automotive battery. A typical 12 volt DC automotive battery with an 80 ampere-hour capacity provides an approximate 1000 watt-hours to operate the computer system in the event of an AC power loss or failure. Accordingly a computer system 200 watt load would operate for approximately 5 hours and a computer system 100 watt load would operate for approximately 10 hours. Other operating times can be determined by extrapolation. Obviously, an automotive battery with a capacity of more than 80 ampere-hours would provide a longer operating time for the same loads. Adding additional automotive batteries or a method to recharge or exchange batteries via a “hot swap” method would also provide an extended operating time for the computer in the event of an extended AC power loss or failure. The use of an automotive 12 volt DC battery in some embodiments of the invention allows “jumping” the UPS automotive battery to another charged battery such as a battery in a vehicle or a 12 volt direct current generator source. It should further be observed that the UPS and computer according to some embodiments of the invention may be used in a mobile operation for example in a truck, fork lift or other mobile vehicles.

It should be noted that the use of readily available automotive batteries, stationary batteries or deep cycle batteries of nominal 12 volts DC and 20-120 ampere-hour capacity permits a cost effective way to obtain almost any reasonable desired level of energy storage.

FIG. 3 shows a flowchart generally indicated as 18 having the basic steps 18a and 18b for implementing the inventive method according to some embodiments of the present invention, including the steps for applying a predetermined desired DC voltage potential from an external uninterruptible power supply to the internal DC voltage power distribution bus in a computer, for example a desktop computer (step 18a), and using an automotive battery, for example a 12 volt DC automotive battery, to provide the predetermined desired DC voltage potential in response to a power loss (step 18b).

It is understood that the aforementioned method as shown for example in FIG. 3 may include other steps known in the art that do not form part of the underlying invention.

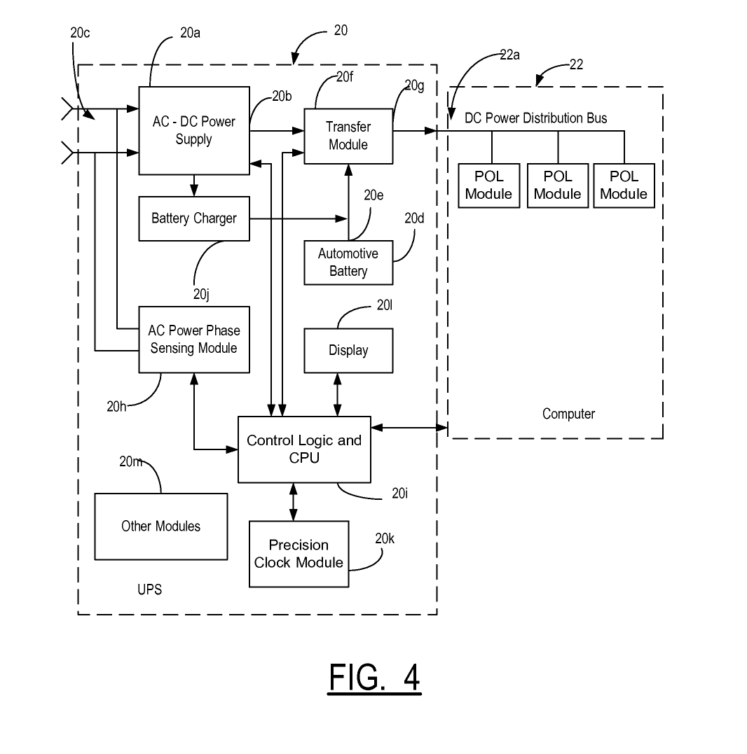

FIG. 4 shows by way of example a schematic functional block diagram of an external uninterruptible power supply (UPS) generally designated 20 as it might be used with a computer generally designated 22 according to some embodiments of the present invention. The UPS 20 includes one or more modules configured as an AC to DC inverterless power supply 20a for generating a predetermined DC voltage signal at its output 20b from an AC voltage power input signal across its input 20c. An automotive battery 20d having a desired capacity is configured and arranged to provide a DC voltage at its output 20e substantially equal to the predetermined DC voltage. One or more module is configured as a transfer module 20f arranged with an output 20g for direct connection to the internal DC voltage power distribution bus 22a in the computer 22. The transfer module 20f is further configured for transferring the predetermined DC voltage generated by the AC to DC power supply 20a from its output 20b connected to the computer internal DC voltage power distribution bus 22a in the presence of an AC input voltage power signal to the automotive battery DC output voltage in the event of an AC voltage power loss. One or more modules are configured as an AC power phase sensing module 20h for sensing the phase of the AC input voltage power signal. One or modules are configured as a controller 20i that is responsive to the sensed phase of the AC input voltage power signal and is configured for determining the presence or absence of the AC input voltage power signal. The controller 20i is further configured for controlling the transfer of the predetermined DC voltage from the output 20b of the AC to DC inverterless power supply 20a to the automotive battery DC output voltage at the automotive battery output 20e. One or more modules are configured as a battery charger 20j for charging the automotive battery. One or more modules configured as a self-contained clock 20k, for example a crystal clock, and arranged for connection to the computer 22 for maintaining the computer operating system time/date data during a loss of the AC input voltage power signal. One or more modules are configured as a display 20l for showing time/date information and text, alphanumeric messages and other data information related to the operating parameters of the external uninterruptible power supply.

Consistent with that described above, the external uninterruptible power supply enabled apparatus may also have other external uninterruptible power supply enabled apparatus modules 20m that do not necessarily form part of the underlying invention and are not described in detail herein.

By way of example, and consistent with that described above, the functionality of the modules 20a, 20f, 20h and/or 20i may be implemented using hardware, software, firmware, or a combination thereof, although the scope of the invention is not intended to be limited to any particular embodiment thereof. In a typical software implementation, the modules 20h and 20i could be one or more microprocessor-based architectures having a microprocessor, a random access memory (RAM), a read only memory (ROM), input/output devices, logic devices and control, data and address buses connecting the same such as shown in FIG. 5. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 20h and 20i being a stand alone module, as shown, or in the combination with other circuitry for implementing another module. Moreover, the real-time part may be implemented in hardware, while the non-real-time part may be done in software.

According to some embodiments the present invention may be implemented as a computer program product comprising a computer readable structure embodying computer program code therein for execution by a computer processor instructions for performing a method comprising applying a predetermined desired DC voltage potential from an external uninterruptible power supply to the internal DC voltage power distribution bus in a computer, for example a desktop computer, and using an automotive battery, for example a 12 volt DC automotive battery, to provide the predetermined desired DC voltage potential in response to a power loss.

The interactions between the major logical functions should be obvious to those skilled in the art for the level of detail needed to gain an understanding of the precepts of the present invention. It should be noted that the basic method of the invention may be implemented with an appropriate signal processor such as shown in FIG. 5, a digital signal processor or other suitable processor to carry out the intended function of the invention.

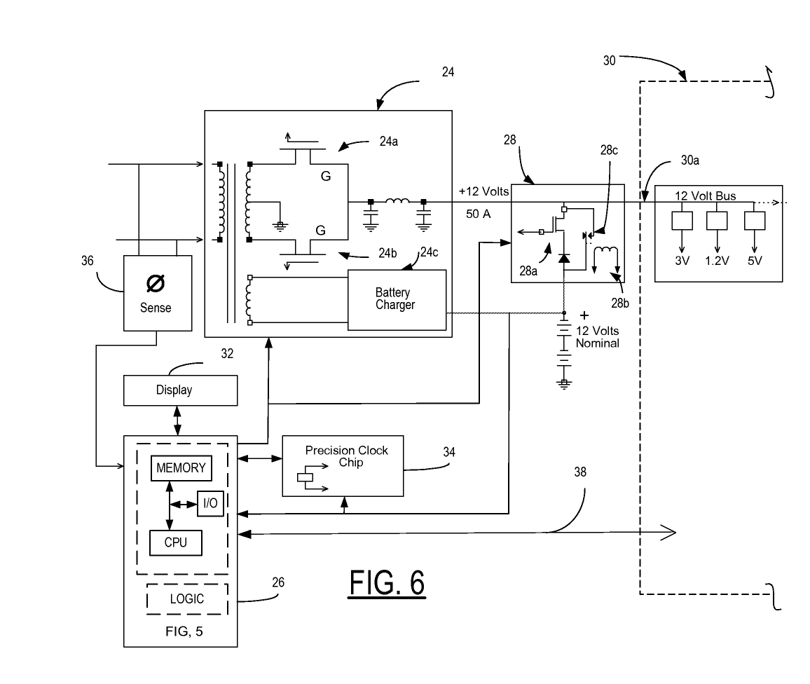

Turning now to FIG. 6, a schematic circuit representation of an external uninterruptible power supply according to some embodiments of the present invention shows representative circuit components which may be required to carry out the intended functions of the external uninterruptible power supply and implement the concept of the invention. A processor such as the signal processor of FIG. 5 carries out the computational and operational control of the external uninterruptible power supply in accordance with one or more sets of instructions stored in a memory. It will be recognized by those skilled in the art that the external uninterruptible power supply may be implemented in other ways other than that shown and described.

Still considering FIG. 6, the AC to DC power supply generally designated 24 converts 120 VAC power to 12 VDC using metal oxide semiconductor field effect transistors (MOSFETS) 24a and 24b as synchronous rectifiers rather than diodes. The advantage of using MOSFETS as synchronous rectifiers is an attempt to avoid heat generation and energy loss which should result in negating the necessity to use cooling fans. A MOSFET, for example, with 0.008 ohm Rds “on” (resistance drain to sink) will only dissipate 20 watts total for both MOSFETS at 50 amperes. The output of the AC to DC power supply in this example is 600 watts. In contrast, a diode pair will dissipate 40 watts and possibly require a fan for cooling. Typically, the AC to DC power supply would provide 200 to 500 watts depending on the application.

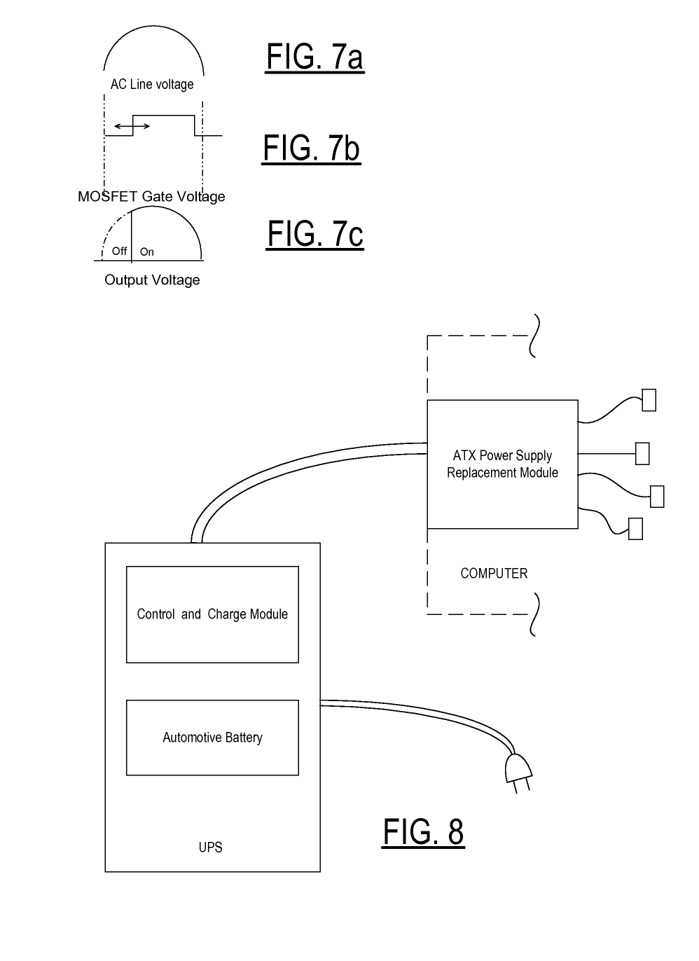

As a further improvement and advantage, the MOSFETs are turned-on by the control logic in the controller 26 in a manner similar to the phase firing of silicon controlled rectifiers. Thus, the MOSFETs are able to control the output voltage, if so desired, over a limited range, without added power dissipation because the MOSFETs are always full-on or full-off as shown by the waveform representation in FIG. 7b which represents the waveform signal at the gate G of the MOSFET 24a. The operation of the MOSFET 24b is the same as the MOSFET 24a except it is 180 degrees out of phase. It should be recognized that silicon controlled rectifiers may also be used if is determined that the thermal losses are acceptable.

The AC to DC power supply 20 schematic shown is a simplified 60 Hertz linear supply, but the same function can be achieved by a switching type supply. The linear type supply is preferred especially for medical and high reliability applications.

The AC to DC power supply 24 also includes a battery charger circuit 24c to maintain the battery at full charge and may be implemented as either a slow charge or fast charge depending on the desired design goal.

The transfer of the output of the AC to DC power supply 24 to the battery output is made via the transfer module 28. The transfer is usually carried out with passive diodes in lower power systems; however in this example, there would be a 35-40 watt loss due to the 50 ampere current flow. Using passive diodes would also result in an approximately 0.8V loss or reduction in the battery voltage, which reduction is significant in a 12 volt DC nominal voltage. In the circuit example of FIG. 6, a power semiconductor 28a is turned-on instantly by the controller 26 upon loss of the AC power line voltage. The power semiconductor 28a is shown by way of example as a field effect transistor (FET), although a silicon controlled rectifier (SCR) or insulated gate bipolar transistor (IGBT) or similar suitable semiconductor device may also be used. Simultaneously a signal is sent to a relay 28b which operates a set of transfer contacts 28c which bypasses the power semiconductor 28a in about 0.015 seconds later. The arrangement of the power semiconductor 28a and the relay 28b allows essentially 100 percent transfer of the battery current without loss to the voltage at the output to the internal distribution bus 30a in the computer 30. The power semiconductor is needed to avoid the momentary loss of power caused by the finite operating time of the mechanical relay; however transfer to the relay happens so fast that negligible power is wasted in the semiconductor, and essentially no loss occurs in the relay contact 28c.

A display 32 is configured for connection to the controller 26 and in this example is arranged to show a clock format (XX:XX). The display shows the time as determined by the precision internal clock 34. The clock 34 may be a crystal based clock, a commercial crystal controlled time keeping chip, or a chip updated by radio in a known manner and is accurate to about 1 second per year. The purpose of the clock is to always be able to provide the correct time to the computer 30 irrespective of power interruptions, etc. The lack of accurate time stamps, or lack of accuracy in general of computer based clocks is thus addressed by the external clock 34 powered by an essentially uninterruptible power supply. The clock 34 may be accessed by the computer operating system via the communication line 38. The display shows time by way of example as (06:50) or shows the actual battery voltage by way of example as (13:80). The time and battery voltage displays may alternate in a distinctive pattern if desired.

An AC power phase sensing module 36 is used to determine the exact phase of the AC power voltage signal and is used by the controller 26 to phase control the MOSFETs 24a and 24b in the AC to DC power supply 24 to roughly regulate the 12 volt DC voltage that is input to the computer DC voltage distribution bus. The AC power sensing module 36 also provides a means of sensing the presence or absence of the AC power line voltage.

The controller 26 in this example contains a microprocessor or CPU that drives the gates of the MOSFETs 24a and 24b, operates the relay 28b, communicates with the computer 30 and drives the display 32. The CPU may also be configured and arranged to function as a digital volt meter, either alone or with auxiliary logic and suitable supporting circuitry.

FIG. 8 shows a functional block diagram of an external uninterruptible power supply according to some embodiments of the invention in which the output of the uninterruptible power supply is arranged and configured to supply the DC output voltage to an ATX power supply replacement module for the computer. The replacement ATX power supply module would be connected via a suitable cable to point of power modules located in the computer.

It is to be understood that the above-described arrangements are only illustrative of the application of the principles of the present invention. Numerous modifications and alternative arrangements may be devised by those skilled in the art without departing from the scope of the present invention.

What is claimed is:

1. A method comprising:
a. applying a predetermined desired DC voltage potential from an external uninterruptible power supply to the internal DC voltage power distribution bus in a computer; and
b. using an automotive battery to provide the predetermined desired DC voltage potential.

2. The method according to claim 1 further comprising using an AC-DC power supply configured to produce the predetermined desired DC voltage from an AC voltage source.

3. The method according to claim 2 further comprising sensing the presence or absence of the AC voltage source for selectively providing the predetermined desired DC voltage from the AC-DC power supply when the AC voltage is present at the input of the AC-DC power supply or providing the predetermined desired DC voltage from the battery when the AC voltage is not present at the input of the AC-DC power supply.

4. The method according to claim 3 further comprising one or more point of power voltage conversion modules connected to the internal DC voltage power distribution bus each configured for providing one or more corresponding different DC voltages for connection to one or more corresponding internal DC voltage distribution buses in the computer.

5. The method according to claim 3 further comprising providing the predetermined desired DC voltage potential to an ATX form factor module having an input connected to the output from the external uninterruptible power supply and an output configured for connection to the computer internal DC voltage power distribution bus.

6. The method according to claim 5 further comprising the ATX form factor module having one or more point of power voltage conversion modules configured for providing one or more corresponding DC voltages for connection to one or more corresponding internal DC voltage power distribution buses in the computer.

7. The method according to claim 3 further comprising the AC-DC power supply having a charger configured for providing a suitable DC voltage potential to the battery for charging the battery at the nominal battery voltage.

8. The method according to claim 3 further comprising transferring the input to the computer internal DC voltage power distribution bus from the output of the AC-DC power supply to the automotive battery in the absence of AC voltage at the input to the AC-DC power supply.

9. The method according to claim 8 further comprising transferring the input to the computer internal DC voltage power distribution bus with a field effect transistor configured as a low loss DC switch.

10. The method according to claim 3 further comprising a the external uninterruptible power supply including a self-contained clock configured for connection to the computer to maintain the computer operating system time data during a loss of AC voltage.

11. An apparatus comprising:
a. an external uninterruptible power supply for applying a direct current voltage to the internal DC voltage power distribution bus of a computer further comprising:
i. one or more modules configured as an AC to DC inverterless power supply for generating a predetermined DC voltage from an AC voltage power input signal;
ii. an automotive battery configured and arranged to provide an output DC voltage substantially equal to the predetermined DC voltage; and
iii. one or more modules arranged with an output for direct connection to the internal DC voltage power distribution bus in the computer and configured for transferring the predetermined DC voltage generated by the AC to DC power supply from its output connected to the computer internal DC voltage power distribution bus in the presence of an AC input voltage power signal to the automotive battery DC output voltage in the event of an AC voltage power loss.

12. The apparatus according to claim 11 further comprising one or more modules configured for sensing the phase of the AC input voltage power signal; and
a. one or modules responsive to the sensed phase of the AC input voltage power signal configured for determining the presence or absence of the AC input voltage power signal and for controlling the transfer of the predetermined DC voltage from the AC to DC inverterless power supply to the automotive battery DC output voltage.

13. The apparatus according to claim 12 further comprising one or more modules configured as a battery charger for charging the automotive battery.

14. The apparatus according to claim 12 further comprising one or more modules configured as a self-contained clock and arranged for connection to the computer for maintaining the computer operating system time/date data during a loss of the AC input voltage power signal.

15. The apparatus according to claim 12 further comprising one or more modules configured as a display for showing time/date information and text, alphanumeric messages and other data information related to the operating parameters of the external uninterruptible power supply.
